(19) United States
(12) Patent Application Publication
(10) Pub. No.: US 2022/0391775 A1
(43) Pub. Date: Dec. 8, 2022

(54) RANDOM FOREST CLASSIFIER CLASS ASSOCIATION RULE MINING

(71) Applicant: EMC IP Holding Company LLC, Hopkinton, MA (US)

(72) Inventors: Paulo Abelha Ferreira, Rio de Janeiro (BR); Adriana Bechara Prado, Niterói (BR)

(21) Appl. No.: 17/338,985

(22) Filed: Jun. 4, 2021

(51) Int. Cl. G06N 20/20; G06F 16/23

(52) U.S. Cl. CPC G06N 20/20; G06F 16/2379

(57) ABSTRACT

Techniques described herein relate a method for explainability for Random Forest (RF) classifiers. The method may include generating a plurality of class labels for a target variable; training a RF classifier using the plurality of class labels and a historical dataset to obtain a trained RF classifier; building a transaction database using the trained RF classifier; identifying a plurality of class association rules using the transaction database; identifying a portion of the plurality of class association rules that have minimum confidence values greater than a minimum confidence value threshold; and presenting the portion of the plurality of class association rules to an interested entity as explainability results.

### BACKGROUND

Computing devices often exist in environments that include many such devices (e.g., servers, virtualization environments, storage devices, mobile devices network devices, etc.). Machine learning algorithms may be deployed in such environments to, in part, assess data generated by or otherwise related to such computing devices. Such machine learning algorithms may be trained and/or executed on a central node, based on data generated by any number of data source nodes. Such a machine learning algorithm may be intended to output any number of possible types of results. However, it is not always apparent why a particular machine learning algorithm outputs a particular result.

### SUMMARY

In general, embodiments described herein relate to a method for explainability for Random Forest (RF) classifiers. The method may include generating a plurality of class labels for a target variable; training a RF classifier using the plurality of class labels and a historical dataset to obtain a trained RF classifier; building a transaction database using the trained RF classifier; identifying a plurality of class association rules using the transaction database; identifying a portion of the plurality of class association rules that have minimum confidence values greater than a minimum confidence value threshold; and presenting the portion of the plurality of class association rules to an interested entity as explainability results.

In general, embodiments described herein relate to a non-transitory computer readable medium that includes computer readable program code, which when executed by a computer processor enables the computer processor to perform a method for explainability for Random Forest (RF) classifiers. The method may include generating a plurality of class labels for a target variable; training a RF classifier using the plurality of class labels and a historical dataset to obtain a trained RF classifier; building a transaction database using the trained RF classifier; identifying a plurality of class association rules using the transaction database; identifying a portion of the plurality of class association rules that have minimum confidence values greater than a minimum confidence value threshold; and presenting the portion of the plurality of class association rules to an interested entity as explainability results.

In general, embodiments described herein relate to a system for explainability for Random Forest (RF) classifiers. The system may include an explainability analyzer, executing on a processor comprising circuitry. The explainability analyzer may be configured to generate a plurality of class labels for a target variable; train a RF classifier using the plurality of class labels and a historical dataset to obtain a trained RF classifier; build a transaction database using the trained RF classifier; identify a plurality of class association rules using the transaction database; identify a portion of the plurality of class association rules that have minimum confidence values greater than a minimum confidence value threshold; and present the portion of the plurality of class association rules to an interested entity as explainability results.

Other aspects of the embodiments disclosed herein will be apparent from the following description and the appended claims.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1A shows a diagram of a system in accordance with one or more embodiments of the invention.

FIG. 1B shows a diagram of an explainability analyzer in accordance with one or more embodiments of the invention.

FIG. 2 shows a flowchart in accordance with one or more embodiments of the invention.

FIG. 3 shows a computing system in accordance with one or more embodiments of the invention.

### DETAILED DESCRIPTION

Specific embodiments will now be described with reference to the accompanying figures.

In the below description, numerous details are set forth as examples of embodiments described herein. It will be understood by those skilled in the art, that also have the benefit of this Detailed Description, that one or more embodiments of embodiments described herein may be practiced without these specific details and that numerous variations or modifications may be possible without departing from the scope of the embodiments described herein. Certain details known to those of ordinary skill in the art may be omitted to avoid obscuring the description.

In the below description of the figures, any component described with regard to a figure, in various embodiments described herein, may be equivalent to one or more like-named components described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

In general, embodiments described herein relate to methods, systems, and non-transitory computer readable mediums storing instructions for improving explainability of machine learning (ML) model results. In one or more embodiments, a Random Forest (RF) classifier may be deployed on a central node (referred to herein as a model coordinator). In one or more embodiments, the central node receives data (i.e., a historical dataset) from any number (i.e., one or more) of operatively connected data source devices.

In one or more embodiments, the central node uses the historical dataset to train and validate the RF classifier, which may then be used to produce results. Such results may place devices having particular feature sets into any number of classes. As an example, the devices may be storage devices, and the classes may be classes of read and/or write response times for the storage devices. The classes may be considered labels. As an example, read response times may be categorized as high, medium, and low (i.e., the class labels). In such an example, the various features and characteristics of the storage devices may be used, along with the read response times exhibited by those devices, to train a RF classifier to classify the storage devices as having high, medium, or low read response times. In one or more embodiments, once trained, such an RF classifier may be used to predict a read response time class for new or other storage devices based on the features and characteristics of the new storage device. Such predictions may be used, for example, when recommending sizing of a storage solution for a new customer that wishes to have a storage solution capable of exhibiting a given read response time.

However, the classifications made by an RF classifier may not always be readily explainable. Thus, embodiments described herein address this problem by improving the explainability of RF classifier results. In one or more embodiments, by producing explainability results that set forth class association rules having a class association rule confidence value above a confidence value threshold.

Modern machine learning (ML) algorithms, such as Random Forests (RFs), are increasingly capable of tackling real-world problems, especially when high number of attributes (features) need to be analyzed. However, the lack of transparency of such ML algorithms may hinder mass adoption. In one or more embodiments, in order for ML to be trusted in many different domains, ML developers as well as ML users, must to be able to reliably understand why ML models make certain decisions. Said another way, ML models should perform well with respect to accuracy, and also be explainable in a human understandable way.

One or more embodiments described herein increase the transparency of RF classifiers by mining class association rules from decision tree paths within the decision trees of the RF classifier. In one or more embodiments, a class association rule is a special case of association rule where the rule consequent contains a single item: a class label. In one or more embodiments, the conditions in the RFs that are most related to how a given class is being predicted are identified.

In one or more embodiments, to improve explainability for RF classifiers, a historical dataset is obtained that includes feature data for any number of features of devices about which the RF classifier will predict classifications. In one or more embodiments, the historical dataset is used to perform a clustering analysis to identify class labels (e.g., high, medium, and low read/write response times). In one or more embodiments, the class labels and the historical dataset are used to train and validate the RF classifier.

Next, in one or more embodiments, the trained RF classifier is mined to build a transaction database. In one or more embodiments, a transaction database is a data structure of any type that stores transaction records. In one or more embodiments, such records include information from a path of a decision tree within the RF, from the root of the decision tree to the class label that resulted from the path, including all decisions made along the way. As a simple example, a transaction database record may include that, for a given device, feature A had a value greater than 2, feature B had a value less than 5, and the class label assigned was medium. In one or more embodiments, such transaction database records are generated for every decision tree path of every decision tree of the trained RF classifier.

Next, in one or more embodiments, the transaction database is used to identify class association rules. In one or more embodiments, a class association rule is a special case of association rule where the consequent is composed of just one item (i.e., the class label), while the antecedent may contain one or more items (i.e., the evaluated conditions that lead down the path of the decision tree to the class label). In one or more embodiments, to find class association rules, frequent items in the transaction database are identified. In one or more embodiments, a frequent item is an antecedent that occurs in the transaction database in more than a minimum threshold number of transaction database records. In one or more embodiments, the percentage value representing the appearances of the frequent item in the transaction database is referred to as an appearance support value.

In one or more embodiments, the frequent items are then analyzed to determine the consequent (i.e., the class label assigned by the RF classifier), and the result is a class association rule. In one or more embodiments, each such rule is further analyzed to determine if the class association rule has a confidence value above a confidence value threshold. In one or more embodiments, the confidence value for a given class association rule is calculated by finding a percentage of entries in the transaction database that exhibit the class association rule (i.e., the class association rule support value), and dividing that value by the appearance support value for the frequent item antecedent of the class association rule.

In one or more embodiments, the value resulting from the aforementioned division is the confidence value associated with the class association rule. In one or more embodiments, a confidence value is calculated for each identified class association rule, and compared with a confidence value threshold. In one or more embodiments, the set of class association rules that have a confidence value above the confidence value threshold become the explainability results. In one or more embodiments, such results are then presented to any interested entity.

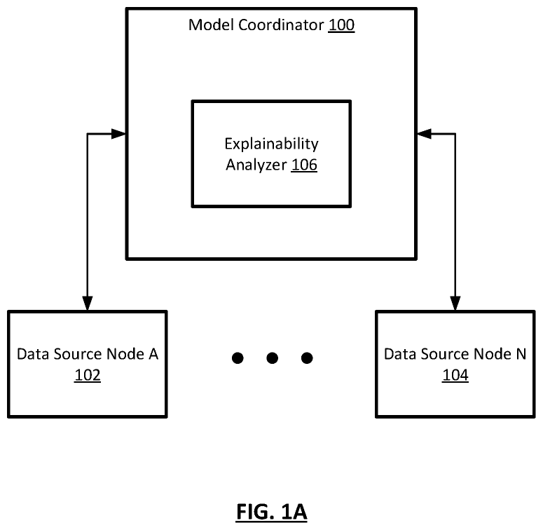

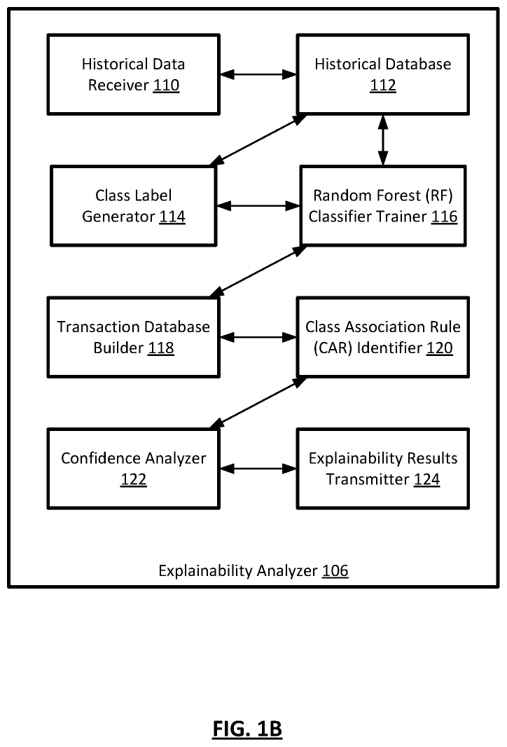

FIG. 1A shows a diagram of a system in accordance with one or more embodiments described herein. The system may include a model coordinator (100) operatively connected to any number of data source nodes (e.g., data source node A (102), data source node N (104)). The model coordinator (100) may include an explainability analyzer (106). Each of these components is described below.

In one or more embodiments, the data source nodes (102, 104) may be computing devices. In one or more embodiments, as used herein, a data source node (102, 104) is any computing device, collection of computing devices, portion of one or more computing devices, or any other logical grouping of computing resources.

In one or more embodiments, a computing device is any device, portion of a device, or any set of devices capable of electronically processing instructions and may include, but is not limited to, any of the following: one or more processors (e.g. components that include integrated circuitry) (not shown), memory (e.g., random access memory (RAM)) (not shown), input and output device(s) (not shown), non-volatile storage hardware (e.g., solid-state drives (SSDs), hard disk drives (HDDs) (not shown)), one or more physical interfaces (e.g., network ports, storage ports) (not shown), any number of other hardware components (not shown), and/or any combination thereof.

Examples of computing devices include, but are not limited to, a server (e.g., a blade-server in a blade-server chassis, a rack server in a rack, etc.), a desktop computer, a mobile device (e.g., laptop computer, smart phone, personal digital assistant, tablet computer, automobile computing system, and/or any other mobile computing device), a storage device (e.g., a disk drive array, a fibre channel storage device, an Internet Small Computer Systems Interface (iSCSI) storage device, a tape storage device, a flash storage array, a network attached storage device, an enterprise data storage array etc.), a network device (e.g., switch, router, multi-layer switch, etc.), a virtual machine, a virtualized computing environment, a logical container (e.g., for one or more applications), and/or any other type of computing device with the aforementioned requirements. In one or more embodiments, any or all of the aforementioned examples may be combined to create a system of such devices, which may collectively be referred to as a computing device or data source node (102, 104). Other types of computing devices may be used as data source nodes without departing from the scope of embodiments described herein.

In one or more embodiments, the non-volatile storage (not shown) and/or memory (not shown) of a computing device or system of computing devices may be one or more data repositories for storing any number of data structures storing any amount of data (i.e., information). In one or more embodiments, a data repository is any type of storage unit and/or device (e.g., a file system, database, collection of tables, RAM, and/or any other storage mechanism or medium) for storing data. Further, the data repository may include multiple different storage units and/or devices. The multiple different storage units and/or devices may or may not be of the same type or located at the same physical location.

In one or more embodiments, any non-volatile storage (not shown) and/or memory (not shown) of a computing device or system of computing devices may be considered, in whole or in part, as non-transitory computer readable mediums storing software and/or firmware.

Such software and/or firmware may include instructions which, when executed by the one or more processors (not shown) or other hardware (e.g. circuitry) of a computing device and/or system of computing devices, cause the one or more processors and/or other hardware components to perform operations in accordance with one or more embodiments described herein.

The software instructions may be in the form of computer readable program code to perform methods of embodiments as described herein, and may, as an example, be stored, in whole or in part, temporarily or permanently, on a non-transitory computer readable medium such as a compact disc (CD), digital versatile disc (DVD), storage device, diskette, tape storage, flash storage, physical memory, or any other non-transitory computer readable medium.

In one or more embodiments, a data source node (102, 104) includes functionality to generate or otherwise obtain any amount or type of telemetry feature data that is related to the operation of the data source node. As used herein, a feature refers to any aspect of a data source device for which telemetry data may be recorded over time. For example, a storage array edge device may include functionality to obtain feature data related to data storage, such as read response time, write response time, number and/or type of disks (e.g., solid state, spinning disks, etc.), model number(s), number of storage engines, cache read/writes and/or hits/misses, size of reads/writes in megabytes, etc.

In one or more embodiments, the system also includes a model coordinator (100). In one or more embodiments, the model coordinator (100) is operatively connected to the data source nodes (102, 104). A model coordinator (100) may be separate from and connected to any number of data source nodes (102, 104). In one or more embodiments, the model coordinator (100) is a computing device (described above).

In one or more embodiments, the model coordinator (100) includes functionality to receive feature data from any number of data source nodes (102, 104), which may be used as a historical dataset. In one or more embodiments, the model coordinator also includes functionality to use the historical dataset to train and validate a RF classifier.

In one or more embodiments, the model coordinator (100) includes an explainability analyzer. In one or more embodiments, an explainability analyzer (106) is any hardware (e.g., circuitry), software, firmware, or any combination thereof that includes functionality to analyze a trained RF classifier to produce explainability results. The explainability analyzer is discussed further in the description of FIG. 1B, below.

In one or more embodiments, the data source nodes (102, 104) and the model coordinator (100) are operatively connected via a network (not shown). A network may refer to an entire network or any portion thereof (e.g., a logical portion of the devices within a topology of devices). A network may include a datacenter network, a wide area network, a local area network, a wireless network, a cellular phone network, or any other suitable network that facilitates the exchange of information from one part of the network to another. A network may be located at a single physical location, or be distributed at any number of physical sites. In one or more embodiments, a network may be coupled with or overlap, at least in part, with the Internet.

While FIG. 1A shows a configuration of components, other configurations may be used without departing from the scope of embodiments described herein. Accordingly, embodiments disclosed herein should not be limited to the configuration of components shown in FIG. 1A.

FIG. 1B shows an example diagram of an explainability analyzer (106) in accordance with one or more embodiments described herein. The explainability analyzer (106) may include any number of components. As shown in FIG. 1B, the explainability analyzer (106) includes a historical dataset receiver (110), a historical database (112), a class label generator (114), a RF classifier trainer (116), a transaction database builder (118), a class association rule (CAR) identifier (120), a confidence analyzer (122), and an explainability results transmitter (124). Each of these components is described below.

In one or more embodiments, an explainability analyzer (106) is all or any portion of a computing device (e.g., model coordinator (100 of FIG. 1A)), as discussed above in the description of FIG. 1A.

In one or more embodiments, the model coordinator (100) includes a historical data receiver (110). In one or more embodiments, a historical data receiver (110) is any hardware (e.g., circuitry), software, firmware, or any combination thereof that includes functionality to obtain/receive historical data for one or more features from one or more data source nodes. In one or more embodiments, historical data is received in any manner capable of collecting data from or about computing devices (e.g., via, at least in part, one or more network interfaces of the model coordinator (100)). In one or more embodiments, historical data is any data about any aspect of any computing device. For example, the data source nodes may be storage devices, and the historical data may relate to read response time, write response time, number and/or type of disks (e.g., solid state, spinning disks, etc.), model number(s), number of storage engines, cache read/writes and/or hits/misses, size of reads/writes in megabytes, etc.

In one or more embodiments, the explainability analyzer (106) includes a historical database (112). In one or more embodiments, a historical database (112) is one or more data repositories for storing any number of data structures storing any amount of data (i.e., information). In one or more embodiments, a data repository is any type of storage unit and/or device (e.g., a file system, database, collection of tables, RAM, and/or any other storage mechanism or medium) for storing data. Further, the data repository may include multiple different storage units and/or devices. The multiple different storage units and/or devices may or may not be of the same type or located at the same physical location. In one or more embodiments, the historical database (112) is operatively connected to the historical data receiver (110), and stores historical data received by the historical data receiver (110).

In one or more embodiments, the explainability analyzer (106) includes a class label generator (114). In one or more embodiments, the class label generator (114) is operatively connected to the historical database (112). In one or more embodiments, a class label generator (114) is any hardware (e.g., circuitry), software, firmware, or any combination thereof that includes functionality to generate class labels for an RF classifier using the historical data stored in the historical database (112). In one or more embodiments, generating class labels includes discretizing the target attribute into different classes (e.g., high, medium, and low response times). In one or more embodiments, the historical data is used to identify any number of class labels. In one or more embodiments, the class labels are identified by applying any clustering algorithms (e.g. Gaussian Mixture Models). In one or more embodiments, based on the clustering analysis, the resultant number of clusters is interpreted as the number of ordinal classes, and a label is assigned to each of the identified classes.

In one or more embodiments, the explainability analyzer (106) includes a RF classifier trainer (116). In one or more embodiments, the RF classifier trainer (116) is operatively connected to the class label generator (114) and the historical database (112). In one or more embodiments, the RF classifier trainer (116) is any hardware (e.g., circuitry), software, firmware, or any combination thereof that includes functionality to train and/or validate an RF classifier using the historical data. In one or more embodiments, an RF classifier predicts a categorical output value (i.e., a class) by using any number of decision trees. In one or more embodiments, each decision tree runs the input historical data through a series of questions regarding feature values until it ends up in a leaf of the decision tree. In one or more embodiments, the leaf contains the predicted class for the given input.

As an example, assume an input X composed of three attributes (or features) called A, B and C. To predict the class associated to X, such input runs through a decision tree and passes a series of inequality tests regarding its feature-values. When the answer is false, the path goes to the left. When the answer is true, the path goes to the right. Thus, each test directs the input towards a sub-tree until it reaches a leaf that includes a class value. In one or more embodiments, a decision tree classifier can be learned from data examples, such as the historical data. In one or more embodiments, a RF classifier consists of many different decision trees whose results are compiled (e.g. through a “majority vote” mechanism) into one final classification. In one or more embodiments, applying many decision trees as part of a RF classifier increases variability and decreases the chance of overfitting the training data.

In one or more embodiments, the explainability analyzer (106) includes a transaction database builder (118). In one or more embodiments, a transaction database builder (118) is operatively connected to the RF classifier trainer (116), and thereby has access to one or more trained RF classifiers. In one or more embodiments, the transaction database builder (118) is any hardware (e.g., circuitry), software, firmware, or any combination thereof that includes functionality to use a trained RF classifier to build a transaction database. In one or more embodiments, a transaction database is a data structure of any type that stores transaction records. In one or more embodiments, such transaction records include information from a path of a decision tree within the RF classifier, from the root of the decision tree to the class label leaf that resulted from traversing the path, including all decisions made along the way. As a simple example, a transaction database record may include that, for a given device, feature A had a value greater than 2, feature B had a value less than 5, and the class label assigned was medium. In one or more embodiments, such transaction database records are generated for every decision tree path of every decision tree of the trained RF classifier.

In one or more embodiments, the explainability analyzer (106) includes a class association rule identifier (120) operatively connected to the transaction database builder (118), and thus has access to the transaction database. In one or more embodiments, a class association rule identifier (120) is any hardware (e.g., circuitry), software, firmware, or any combination thereof that includes functionality to use the transaction database, and the transaction database records therein, to identify class association rules. In one or more embodiments, a class association rule is a special case of association rule where the consequent is composed of just one item (i.e., the class label), while the antecedent may contain one or more items (i.e., the evaluated conditions that lead down the path of the decision tree to the class label). In one or more embodiments, to find class association rules, frequent items in the transaction database are identified. In one or more embodiments, a frequent item is an antecedent that occurs in the transaction database in more than a minimum threshold number of transaction database records. In one or more embodiments, the percentage value representing the appearances of the frequent item in the transaction database is referred to as an appearance support value. In one or more embodiments, the frequent items are then analyzed to determine the consequent (i.e., the class label assigned by the RF classifier), and the result is a class association rule.

In one or more embodiments, the explainability analyzer (106) includes a confidence analyzer (122) operatively connected to the class association rule identifier (120). In one or more embodiments, a confidence analyzer (122) is any hardware (e.g., circuitry), software, firmware, or any combination thereof that includes functionality to analyze the class association rules identified by the class association rule identifier (120) and the transaction database to calculate a confidence value for each class association rule, and compare the confidence value with a confidence value threshold. In one or more embodiments, the confidence value for a given class association rule is calculated by finding a percentage of entries in the transaction database that exhibit the class association rule (i.e., the class association rule support value), and dividing that value by the appearance support value for the frequent item antecedent portion of the class association rule.

In one or more embodiments, the value resulting from the aforementioned division is the confidence value associated with the class association rule. In one or more embodiments, a confidence value is calculated for each identified class association rule, and compared with a confidence value threshold. In one or more embodiments, the set of class association rules that have a confidence value above the confidence value threshold are the explainability results produced by explainability analyzer (106).

In one or more embodiments, the explainability analyzer (106) includes an explainability results transmitter (124). In one or more embodiments, the explainability results transmitter (124) is operatively connected to the confidence analyzer (122), and thus has access to the explainability results. In one or more embodiments, the explainability results transmitter (124) is any hardware (e.g., circuitry), software, firmware, or any combination thereof that includes functionality to transmit data using any type of data transmission. In one or more embodiments, the data transmitted is the explainability results. In one or more embodiments, the explainability results are transmitted to any interested entity. As an example, the explainability results may be transmitted over a network to a member of a storage solution sales team that is seeking to understand and be able to explain why certain storage solutions are recommended to achieve desired response times specified in a service level agreement for a customer.

While FIG. 1B shows a configuration of components, other configurations may be used without departing from the scope of embodiments described herein. For example, although FIG. 1B shows all components as part of the same device, any of the components may be grouped in sets of one or more components which may exist and execute as part of any number of separate and operatively connected devices. As another example, a single component may be configured to perform all or any portion of any of the functionality performed by the components shown in FIG. 1B. Accordingly, embodiments disclosed herein should not be limited to the configuration of components shown in FIG. 1B.

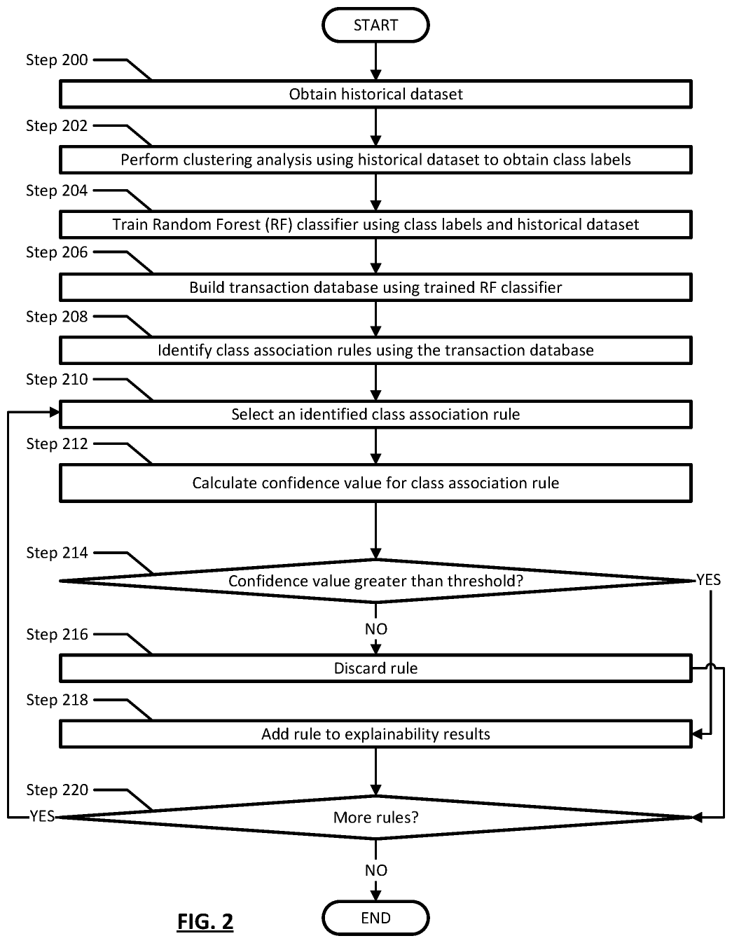

FIG. 2 shows a flowchart describing a method for ML model explainability analysis in accordance with one or more embodiments disclosed herein.

While the various steps in the flowchart shown in FIG. 2 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel with other steps of FIG. 2.

In Step 200, a historical dataset is obtained. In one or more embodiments, the historical dataset is obtained by an explainability analyzer of a model coordinator. In one or more embodiments, the historical dataset is obtained from any one or more data source devices. In one or more embodiments, the historical dataset is obtained via any technique for receiving data, such as, for example, over a network. The historical dataset may be received at one time, or may be received at any number of different times and aggregated to form the historical dataset.

In Step 202, the historical dataset obtained in Step 200 is used to obtain any number of class labels for use by an RF classifier. In one or more embodiments, the class labels are obtained by performing a clustering analysis using the historical dataset. In one or more embodiments, the clustering analysis is performed using the feature for which a prediction is to be obtained, such as, for example, read response time of a storage device.

In Step 204, an RF classifier is trained using the class labels obtained in Step 202, and the historical dataset obtained in Step 200.

In Step 206, a transaction database is built using the RF classifier trained in Step 204. In one or more embodiments, the transaction database includes a transaction database record corresponding to each path of each decision tree of the RF classifier. In one or more embodiments, each transaction database record includes an antecedent that includes any number of discrete decisions made along a path from root to leaf of a decision tree of the RF classifier, and a consequent that is the class label of the leaf of the path.

In Step 208, class association rules are identified using the transaction database, and the records therein. In one or more embodiments, to find class association rules, frequent items in the transaction database are identified. In one or more embodiments, a frequent item is an antecedent that occurs in the transaction database in more than a minimum threshold number of transaction database records. In one or more embodiments, the percentage value representing the appearances of the frequent item in the transaction database is referred to as an appearance support value. In one or more embodiments, the frequent items are then analyzed to determine the consequent (i.e., the class label assigned by the RF classifier), and the result is a class association rule.

In Step 210, a class association rule is selected for analysis. Any scheme may be used for selecting one of the identified class association rules. For example, a class association rule may be randomly selected from among the set of identified class association rules.

In Step 212, a confidence value is calculated for the selected class association rule. In one or more embodiments, the confidence value for a given class association rule is calculated by finding a percentage of entries in the transaction database that exhibit the class association rule (i.e., the class association rule support value), and dividing that value by the appearance support value for the frequent item antecedent of the class association rule. In one or more embodiments, the value resulting from the aforementioned division is the confidence value associated with the class association rule.

In Step 214, a determination is made as to whether the class association rule confidence value is greater than a confidence value threshold. A confidence value threshold may be any value, and may be configured or set by any entity. For example, the confidence value threshold may be set by a domain expert with knowledge of the domain of data represented by the historical dataset. In one or more embodiments, if the class association rule confidence value is greater than the confidence value threshold, the method proceeds to Step 218. In one or more embodiments, if the class association rule confidence value is not greater than the confidence value threshold, the method proceeds to Step 216

In Step 216, the class association rule for which the confidence value was not greater than the threshold is discarded. Discarding a rule, as used herein, means not including the rule in explainability results for the RF classifier. In one or more embodiments, a class association rule having a confidence value below a confidence value threshold is a class association rule that cannot be used to explain why a RF classifier applied a certain class label based on input data. In one or more embodiments, after discarding the rule, the method proceeds to Step 220.

In Step 218, based on a determination that the confidence value for a class association rule is greater than a confidence value threshold, the class association rule is added to the explainability results for the RF classifier.

In Step 220, a determination is made as to whether there are any more class association rules. In one or more embodiments, if there are more class association rules, the method returns to Step 210. In one or more embodiments, if there are no additional class association rules, the method ends.

In one or more embodiments, although not shown in FIG. 2, the explainability results, which include class association rules having a confidence value greater than a confidence value threshold, are transmitted to an interested entity seeking to understand why the RF classifier made certain classifications based on the input data.

### Example Use Case

The above describes systems and methods for producing explainability results for a trained RF classifier. As such, one of ordinary skill in the art will recognize that there are many variations of how such ML model training may occur, and how explainability results may be produced. However, for the sake of brevity and simplicity, consider the following simplified scenario to illustrate the concepts described herein.

Consider a scenario in which a RF classifier includes two decision trees. In the first tree, the root decision is whether a value for feature A is greater than or equal to 0.82. If false, the next decision is whether the value for feature B is greater than or equal to 5.71. If false, that decision tree path results in a class label of low. If true, the decision tree path results in a class label of medium.

If the root decision of whether the value for feature A was greater than or equal to 0.82 is true, the next decision is whether the value for feature C is greater than or equal to 0.03. If false, that decision tree path results in a class label of medium. If true, the decision tree path results in a class label of high.

In the second tree, the root decision is whether a value for feature A is greater than or equal to 0.82. If false, the next decision is whether the value for feature B is greater than or equal to 5.71. If false, that decision tree path results in a class label of low. If true, the decision tree path results in a class label of medium.

If the root decision of whether the value for feature A was greater than or equal to 0.82 is true, the next decision is whether the value for feature D is greater than or equal to 0.1. If false, that decision tree path results in a class label of medium. If true, the decision tree path results in a class label of high.

In the above described two decision trees of the RF classifier, there are 8 paths from root to leaf. Thus, a transaction database is built that includes 8 transaction database records. Each record includes the decisions made along one of the paths as the antecedent, and the resulting class label as the consequent.

Feature A less than 0.82 and feature B less than 5.71 is identified as a frequent item in the transaction database, as the percentage of records in which that antecedent appears is higher than an appearance support value threshold. One class association rule that is identified for the frequent item includes a consequent class label of low. The class association rule has a support value of 25%, as it appears in 2 of the 8 transaction database records. The frequent item has an appearance support value of 25%, as it appears in 2 of the 8 transaction database records. The confidence value for the class association rule is thus 25% divided by 25%, or 100%. 100% is above the confidence value threshold of 80%. Therefore, the class association rule is included in the explainability results.

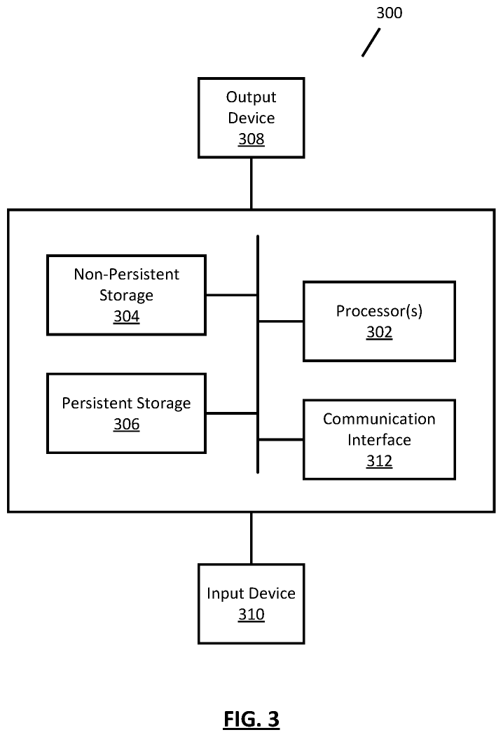

As discussed above, embodiments of the invention may be implemented using computing devices. FIG. 3 shows a diagram of a computing device in accordance with one or more embodiments of the invention. The computing device (300) may include one or more computer processors (302), non-persistent storage (304) (e.g., volatile memory, such as random access memory (RAM), cache memory), persistent storage (306) (e.g., a hard disk, an optical drive such as a compact disk (CD) drive or digital versatile disk (DVD) drive, a flash memory, etc.), a communication interface (312) (e.g., Bluetooth interface, infrared interface, network interface, optical interface, etc.), input devices (310), output devices (308), and numerous other elements (not shown) and functionalities. Each of these components is described below.

In one embodiment of the invention, the computer processor(s) (302) may be an integrated circuit for processing instructions. For example, the computer processor(s) may be one or more cores or micro-cores of a processor. The computing device (300) may also include one or more input devices (310), such as a touchscreen, keyboard, mouse, microphone, touchpad, electronic pen, or any other type of input device. Further, the communication interface (312) may include an integrated circuit for connecting the computing device (300) to a network (not shown) (e.g., a local area network (LAN), a wide area network (WAN) such as the Internet, mobile network, or any other type of network) and/or to another device, such as another computing device.

In one embodiment of the invention, the computing device (300) may include one or more output devices (308), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (302), non-persistent storage (304), and persistent storage (306). Many different types of computing devices exist, and the aforementioned input and output device(s) may take other forms.

The problems discussed above should be understood as being examples of problems solved by embodiments of the invention and the invention should not be limited to solving the same/similar problems. The disclosed invention is broadly applicable to address a range of problems beyond those discussed herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for explainability for Random Forest (RF) classifiers, the method comprising:
generating a plurality of class labels for a target variable;
training a RF classifier using the plurality of class labels and a historical dataset to obtain a trained RF classifier;
building a transaction database using the trained RF classifier;
identifying a plurality of class association rules using the transaction database;
identifying a portion of the plurality of class association rules that have minimum confidence values greater than a minimum confidence value threshold; and
presenting the portion of the plurality of class association rules to an interested entity as explainability results.

2. The method of claim 1, wherein generating the plurality of class labels comprises performing a clustering analysis using the historical dataset.

3. The method of claim 1, wherein the trained RF classifier comprises a plurality of decision trees.

4. The method of claim 3, wherein building the transaction database comprises:
generating, using a decision tree of the plurality of decision trees, a transaction database record comprising a class label of the plurality of class labels associated with a plurality of decision tree step results between a root of the decision tree and a decision tree leaf comprising the class label.

5. The method of claim 1, wherein identifying the plurality of class association rules comprises:
identifying a plurality of frequent items in the transaction database using a minimum support value; and
generating an association rule comprising a frequent item of the plurality of frequent items and a class label in the transaction database.

6. The method of claim 5, wherein identifying the portion of the plurality of class association rules that have the minimum confidence values greater than the minimum confidence value threshold comprises:
calculating an appearance support value for the frequent item of the plurality of frequent items;
calculating an association rule support value for the association rule;
calculating an association rule confidence value using the association rule support value and the appearance support value; and
performing a comparison of the association rule confidence value and the minimum confidence value threshold.

7. The method of claim 6, wherein calculating the association rule confidence value comprises dividing the appearance support value by the association rule support value.

8. The method of claim 5, wherein identifying the plurality of frequent items comprises:
determining a quantity of transaction records in the transaction database that comprises the frequent item of the plurality of frequent items; and
performing a comparison of the quantity with the minimum support value.

9. The method of claim 5, wherein calculating an association rule support value comprises determining a percentage of transaction database records in the transaction database that include the association rule.

10. A non-transitory computer readable medium comprising computer readable program code, which when executed by a computer processor enables the computer processor to perform a method for explainability for Random Forest (RF) classifiers, the method comprising:
generating a plurality of class labels for a target variable;
training a RF classifier using the plurality of class labels and a historical dataset to obtain a trained RF classifier;
building a transaction database using the trained RF classifier;
identifying a plurality of class association rules using the transaction database;
identifying a portion of the plurality of class association rules that have minimum confidence values greater than a minimum confidence value threshold; and
presenting the portion of the plurality of class association rules to an interested entity as explainability results.

11. The non-transitory computer readable medium of claim 10, wherein generating the plurality of class labels comprises performing a clustering analysis using the historical dataset.

12. The non-transitory computer readable medium of claim 10, wherein the trained RF classifier comprises a plurality of decision trees.

13. The non-transitory computer readable medium of claim 12, wherein the method performed by executing the computer readable program code further comprises:
generating, using a decision tree of the plurality of decision trees, a transaction database record comprising a class label of the plurality of class labels associated with a plurality of decision tree step results between a root of the decision tree and a decision tree leaf comprising the class label.

14. The non-transitory computer readable medium of claim 10, wherein the method performed by executing the computer readable program code further comprises:
identifying a plurality of frequent items in the transaction database using a minimum support value; and
generating an association rule comprising a frequent item of the plurality of frequent items and a class label in the transaction database.

15. The non-transitory computer readable medium of claim 14, wherein identifying the portion of the plurality of class association rules that have the minimum confidence values greater than the minimum confidence value threshold comprises:
calculating an appearance support value for the frequent item of the plurality of frequent items;
calculating an association rule support value for the association rule;
calculating an association rule confidence value using the association rule support value and the appearance support value; and
performing a comparison of the association rule confidence value and the minimum confidence value threshold.

16. The non-transitory computer readable medium of claim 15, wherein calculating the association rule confidence value comprises dividing the appearance support value by the association rule support value.

17. The non-transitory computer readable medium of claim 14, wherein identifying the plurality of frequent items comprises:
determining a quantity of transaction records in the transaction database that comprises the frequent item of the plurality of frequent items; and
performing a comparison of the quantity with the minimum support value.

18. The non-transitory computer readable medium of claim 14, wherein calculating an association rule support value comprises determining a percentage of transaction database records in the transaction database that include the association rule.

19. A system for explainability for Random Forest (RF) classifiers, the system comprising:
an explainability analyzer, executing on a processor comprising circuitry, and configured to:
generate a plurality of class labels for a target variable;
train a RF classifier using the plurality of class labels and a historical dataset to obtain a trained RF classifier;
build a transaction database using the trained RF classifier;
identify a plurality of class association rules using the transaction database;
identify a portion of the plurality of class association rules that have minimum confidence values greater than a minimum confidence value threshold; and
present the portion of the plurality of class association rules to an interested entity as explainability results.

20. The system of claim 19, wherein the explainability analyzer is further configured to:
identify a plurality of frequent items in the transaction database using a minimum support value; and
generate an association rule comprising a frequent item of the plurality of frequent items and a class label in the transaction database.
